(19) United States
(12) Patent Application Publication
(10) Pub. No.: US 2010/0064053 A1
(43) Pub. Date: Mar. 11, 2010

(54) RADIO WITH PERSONAL DJ

(75) Inventors: William Bull, Mountain View, CA (US); Ben Rottler, San Francisco, CA (US)

Correspondence Address: TOWNSEND AND TOWNSEND AND CREW, LLP, TWO EMBARCADERO CENTER, 8TH FLOOR, SAN FRANCISCO, CA, 94111-3834, US

(73) Assignee: Apple Inc., Cupertino, CA (US)

(21) Appl. No.: 12/207,316

(22) Filed: Sep. 9, 2008

(51) Int. Cl. G06F 15/16

(52) U.S. Cl. 709/231

(57) ABSTRACT

An electronic device, such as a media player or portable media device, can provide enhanced playback of personalized or synthesized content in addition to streaming content. During playback of one or more media items associated with streaming content, content generated or synthesized from data or other information obtained from data sources can be personalized to be integrated with the one or more media items being streamed or broadcast. Personalized or synthesized content may be generated dynamically based on a determination that personalized content is also to be played back with the streaming content. A user may configure data feeds associated with weather information, horoscope, calendar, caller-ID, voicemail, or the like, and have content specifically generated to represented the data feeds interjected into a program or between songs at random or scheduled intervals.

### FIELD OF THE INVENTION

The present invention relates to providing playback of streaming content on electronic devices, such as media players or portable media devices. More particularly, the present invention related techniques for presenting content generated from data sources in addition to streaming content.

### BACKGROUND OF THE INVENTION

Electronic devices, such as portable media players, cellular phones, personal digital assists (PDAs), and the like, are prevalent in today's marketplace, as are the peripheral electronic devices that support their use, such as docking stations and the like. As competition in the personal electronics marketplace becomes ever more heated, consumers have become more demanding in terms of both the functionality and use of such devices.

Users listen to, watch, or otherwise receive and consume content in a variety of contexts. For example, it is common to listen to music while driving, riding public transit, exercising, hiking, doing chores, or the like. Additionally, users now are more often using media players to receive radio, television, and satellite broadcasts, Global Positioning and other broadcast-based location services for navigation and recreation in addition to the playback of content stored on the media players.

Conventionally, a media player or portable media player can be capable of playing media, such as audio (e.g., songs) or video (e.g., movies) for the benefit of its user. When playing audio, if the media player includes a display, the display can present the name of the song, artist and other information pertaining to the song. In the case of playing a video, the display can be used to present the video.

Unfortunately, however, media players generally may not able to dynamically create content for playback. For example, when playing a series of media items from a media item group (e.g., playlist), a media player or portable media device may merely sequence through the fixed set of media items. Although playback can be stopped, the content being played may nevertheless be limited to playback of the media items within the media item group.

Accordingly, what is desired are improved methods and apparatus for solving the problems discussed above. Additionally, what is desired are improved methods and apparatus for reducing some of the drawbacks discussed above.

### BRIEF SUMMARY OF THE INVENTION

In various embodiments, an electronic device, such as a media player or portable media device, can provide enhanced playback of personalized content in addition to streaming content. According to one aspect of the invention, during media playback, content can be generated from data or other information obtained from data sources to be personalized and integrated with one or more media items being streamed or broadcast. For example, an electronic device offering media playback of network-based radio stations can not only play back media item data from the network-based radio stations, but can also play back other media data that may be dynamically generated and personalized to a user of the electronic device.

In some embodiments, the playback or presentation of content, such as songs, movies, images, or other media assets being streamed to electronic devices can be enhanced through the incorporation into the playback of content that has been specifically personalized for a user or group of users of the electronic device. The personalized content can be generated from information obtained from data sources, such as personal calendars, voicemail boxes, e-mail inboxes, or data sources from the Internet identified by a user of the electronic device. The personalized content may be generated in real-time or near real-time for presentation with streaming content or prerecorded for storage and subsequent retrieval on an electronic device for playback with streaming content.

In further embodiments, a user of an electronic device, such as a media player or portable media device, can determine when and how much of the personalized content is to be presented (e.g., played) in conjunction with content streamed from one or more sources. Based on user preferences, for example, an agent, much like a personal radio DJ, may determine how much of the personalized content should be dynamically generated to feed data, such as horoscopes, calendar information, voicemail and e-mail data, and metadata associated with content, to the user. The agent may determine to present or otherwise initiate playback of the personalized content at random intervals or at scheduled intervals in conjunction with streaming content. In still further embodiments, the personalized content may be mixed with streaming content, being played simultaneously, as an overlay, or during transitions of content within a stream.

In some embodiments, the personalized content may be generated using one or more voice synthesis techniques from data sources, for example, to create audio content informing the listener of the weather or reminding the listener of an upcoming appointment that can be played or presented in conjunction with streaming content. Accordingly, an electronic device, such as a media player or portable media device, offering playback or presentation of content streamed from a variety of sources can not only present media item data associated with the streaming content, but can also enhance a user's experience with content presented in conjunction with the streaming content that has been personalized from data obtained from data sources identified by the user.

A further understanding of the nature, advantages, and improvements offered by those inventions disclosed herein may be realized by reference to remaining portions of this disclosure and any accompanying drawings.

### BRIEF DESCRIPTION OF THE DRAWINGS

In order to better describe and illustrate embodiments and/or examples of those inventions disclosed herein, reference may be made to one or more accompanying drawings. The additional details or examples used to describe the accompanying drawings should not be considered as limitations to the scope of any of the disclosed inventions, the presently described embodiments and/or examples, and the presently understood best mode of these inventions.

FIG. 1 is a block diagram of a media player that may incorporate embodiments of the present invention;

FIG. 2 is a block diagram of a first media player configured to receive streaming content in one embodiment according to the present invention;

FIG. 3 is a block diagram of a second media player configured to receive streaming content in one embodiment according to the present invention;

FIG. 4 is a block diagram of a third media player configured to receive streaming content in one embodiment according to the present invention;

FIGS. 5A and 5B are block diagrams of streaming media systems for presenting personalized content with streaming content in various embodiment according to the present invention;

FIG. 6 is a block diagram of an agent configured to generate personalized content based on information obtained from one or more data sources for playback with streaming content in one embodiment according to the present invention;

FIG. 7 is a flowchart of a method for presenting personalized content with streaming content in one embodiment according to the present invention;

FIG. 8 is a diagram is a diagram of conventional playback of streaming content in one embodiment according to the present invention;

FIG. 9 is a diagram of personalized content generated according to one embodiment of the present invention;

FIG. 10 is a diagram of playback of interleaved media data in one embodiment according to the present invention;

FIG. 11 is a diagram of playback of interlaced media data in one embodiment according to the present invention;

FIG. 12 is a diagram of playback of combined media data in one embodiment according to the present invention;

FIG. 13 is a flowchart of a method for presenting personalized content generated using voice synthesis in one embodiment according to the present invention;

FIG. 14 is a flowchart of a method for presenting personalized content based on a schedule in one embodiment according to the present invention;

FIG. 15 is a flowchart of a method for presenting synthesized content based on a verbosity parameter in one embodiment according to the present invention; and

FIG. 16 is a block diagram of an electronic device that may incorporate embodiments of the present invention.

### DETAILED DESCRIPTION OF THE INVENTION

Various embodiments can be well suited for electronic devices having audio playback capabilities, such as media devices (e.g., digital media players or portable MP3 players) or other portable multi-function devices (e.g., mobile telephone or Personal Digital Assistant). For example, portable devices can often store and play digital media assets (media items), such as music (e.g., songs), videos (e.g., movies), audiobooks, podcasts, meeting recordings, and/or other multimedia recordings. Portable devices, such as portable media players or other portable multi-function devices, can also be small and highly portable. Often, portable devices are hand-held devices, such as hand-held media players or hand-held multi-function devices, which can be easily held by and within a single hand of a user. Portable devices can also be pocket-sized, miniaturized or wearable.

In various embodiments, the playback or presentation of content, such as songs, movies, images, or other media assets being streamed to electronic devices can be enhanced through the incorporation into the playback of content that has been specifically personalized for a user or group of users of the electronic device. The personalized content can be generated from information obtained from data sources, such as personal calendars, voicemail boxes, e-mail inboxes, or data sources from the Internet identified by a user of the electronic device. The personalized content may be generated in real-time or near real-time for presentation with streaming content or prerecorded for storage and subsequent retrieval on an electronic device for playback with streaming content.

In some embodiments, a user of an electronic device, such as a media player or portable media device, can determine when and how much of the personalized content is to be presented (e.g., played) in conjunction with content streamed from one or more sources. Based on user preferences, for example, an agent, much like a personal radio DJ, may determine how much of the personalized content should be dynamically generated to feed data, such as horoscopes, calendar information, voicemail and e-mail data, and metadata associated with content, to the user. The agent may determine to present or otherwise initiate playback of the personalized content at random intervals or at scheduled intervals in conjunction with streaming content. In further embodiments, the personalized content may be mixed with streaming content, being played simultaneously, as an overlay, or during transitions of content within a stream.

In still further embodiments, the personalized content may be generated using one or more voice synthesis techniques from data sources, for example, to create audio content informing the listener of the weather or reminding the listener of an upcoming appointment that can be played or presented in conjunction with streaming content. Accordingly, an electronic device, such as a media player or portable media device, offering playback or presentation of content streamed from a variety of sources can not only present media item data associated with the streaming content, but can also enhance a user's experience with content presented in conjunction with the streaming content that has been personalized from data obtained from data sources identified by the user.

Aspects of the environments within which various examples and/or embodiments of those invention found within the specification operate will first be described.

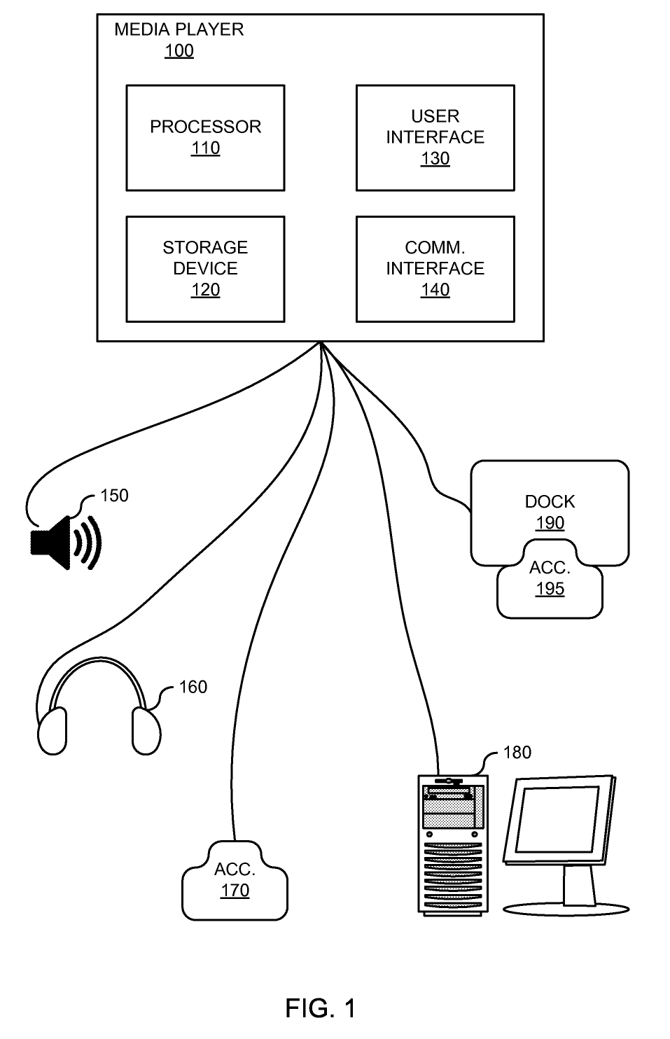

FIG. 1 is a block diagram of media player 100 that may incorporate embodiments of the present invention. In general, a media player stores content and/or media assets, such as audio tracks, movies, or photos that can be played or displayed on the media player. One example of media player 100 can be the iPod® media player, which is available from Apple, Inc. of Cupertino, Calif. Another example of media player 100 can be a personal computer, such as a laptop or desktop.

In this example, media player 100 includes processor 110, storage device 120, user interface 130, and communications interface 140. Processor 110 can control various functionalities associated with media player 100. Media play 100 may output audio content, video content, image content, and the like. Media player 100 may also output metadata or other information associated with content, such as track information and album art.

Typically, a user may load or store content onto media player 100 using storage device 120. Storage device 120 can include read-only memory (ROM), random access memory (RAM), non-volatile memory, flash memory, floppy disk, hard disk, or the like. A user may interact with user interface 130 of media player 100 to view or consume content. Some examples of user interface 130 can include buttons, click wheels, touch pads, displays, touch screens, and other input/output devices.

Media player 100 can include one or more connectors or ports that can be used to load content, retrieve content, interact with applications running on media player 100, interface with external devices, and the like. In this example, media player 100 includes communications interface 140. Some examples of communications interface 140 can include universal serial bus (USB) interfaces, IEEE 1394 (or FireWire/iLink®) interfaces, universal asynchronous receiver/transmitters (UARTs), wired and wireless network interfaces, transceivers, and the like. Media player 100 may connect to devices, accessories, private and public communications networks (e.g., the Internet), or the like, using communications interface 140.

In one example, media player 100 can be coupled via a wired and/or wireless connector or port to output audio and/or other information to speakers 150. In another example, media player 100 may be coupled via a wired and/or wireless connector or port to output audio and/or other information to headphones 160. In yet another example, media player 100 may be coupled via a wired and/or wireless connector or port to interface with an accessory 170 or a host computer 180. The same connector or port may enable different connections at different times.

Media player 100 can be physically inserted into docking system 190. Media player 100 may be coupled via a wired and/or wireless connector or port to interface with docking system 190. Docking system 190 may also enable one or more accessory devices 195 to couple with wires or wirelessly to interface with media player 100. Many different types and functionalities of accessory devices 170 and 195 can interconnect to or with media player 100. For example, an accessory may allow a remote control to wirelessly control media player 100. As another example, an automobile may include a connector into which media player 100 may be inserted such that an automobile media system can interact with media player 100, thereby allowing media content stored on media player 100 to be played within the automobile.

In various embodiments, media player 100 can receive content or other media assets from a computer system (e.g., host computer 160). The computer system may serve to enable a user to manage media assets stored on the computer system and/or stored on media player 100. As an example, communications interface 140 may allow media player 100 to interface with host computer 160. Host computer 160 may execute a media management application to manage media assets, such as loading songs, movies, photos, or the like, onto media player 100. The media management application may also create playlists, record or rip content, schedule content for playback or recording, or the like. One example of a media management application can be iTunes®, produced by Apple, Inc. of Cupertino, Calif.

In some embodiments, media player 100 can receive content or other media assets from a variety of sources, such as over the air radio or television (TV), satellite radio or TV, cable TV or music services, Internet streaming broadcasts, podcasts, satellite broadcasts, fiber optic distribution, or the like. Content or other media assets may be transmitted in analog, digital and/or hybrid forms. Content or other media assets may be transmitted in a content stream. Streaming content may include a serialization or sequence of content or other media assets. Streaming content may be distributed in real time, such as a broadcast, or in non-real time, such as a network stream or podcast. As used herein, a “broadcast” can refer generally to real time distribution of content (e.g., audio and/or visual data, etc.) or other media assets via a wired or wireless medium to an arbitrary number of receivers that may be tuned in to receive it. In general, a receiver does not control when a broadcast begins or ends, although some receivers (e.g., audio or video recorders) may be able to store content streams for later presentation to a user.

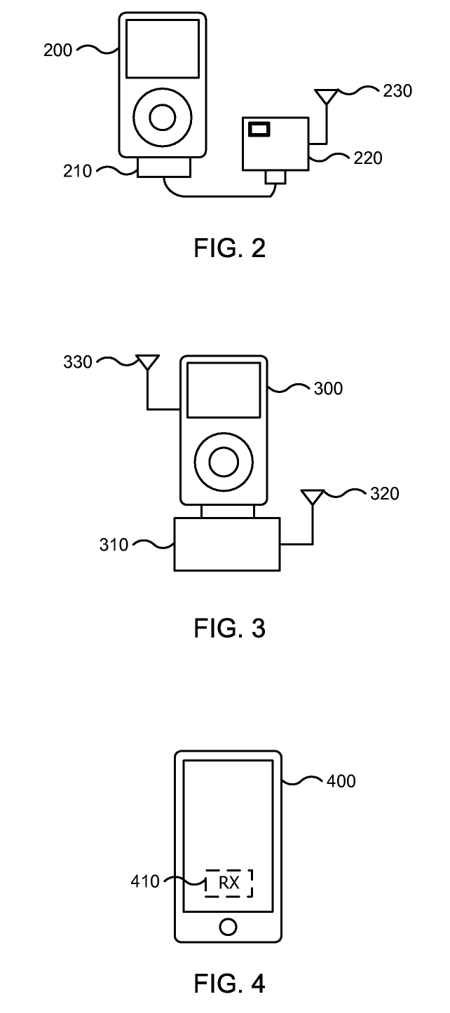

FIG. 2 is a block diagram of media player 200 configured to receive streaming content in one embodiment according to the present invention. Media player 200 may be embodied as media player 100 of FIG. 1. Media player 200 can be coupled via accessory device 210 to receiver unit 220. Receiver unit 200 may be capable of receiving content streams from one or more sources (not shown) using antenna 230.

The streaming content from the one or more sources can include media item content as well as metadata identifying the content (e.g., track title, album, artist, type, rating, bit-rate, encoding, location, or store/product) and/or the source of the content (e.g., broadcaster, station frequency, station name, or station identification). Receiver unit 220 can capture content and metadata (and/or a portion thereof) and may provide the content and metadata (and/or the portion thereof) to media player 200, either in response to a user command or automatically.

Receiver unit 220 can be used to receive streaming content from the one or more sources via one or more media. In general, any medium or combination of media can be supported. In this example, receiver unit 220 can connect to antenna 230, which can be capable of detecting broadcasts of content from the one or more sources via a wireless medium (e.g., FM or AM radio in standard and/or HD formats, over the air TV, satellite TV or radio, WiFi, cellular communication network, etc.). Receiver unit 220 may also connect to a cable (not shown) and thus be capable of receiving broadcasts of content from the one or more sources via a wired medium (e.g., cable TV service, wired Internet connection, or the like). Receiver unit 220 may include any hardware and/or software elements usable to extract content and/or metadata from wired and/or wireless media as desired; the particular components will depend on the medium (or media) supported. Any combination or sub-combination of wired and/or wireless media can be supported.

Receiver unit 220 can deliver signals corresponding to streaming content received from the one or more sources to media player 200 to deliver content or other media assets and/or metadata associated with the received content streams. Media player 200 can include appropriate decoding and processing components to extract content and/or metadata from content streams received from the one or more sources in encoded form. These components can generate analog and/or digital signals suitable for driving video and/or audio output devices, such as display devices and/or speakers. Such output devices can be integrated into media player 200, an accessory (e.g., accessory 170 of FIG. 1), or the devices can be supplied as external components coupled to the accessory or media player 200 via suitable connections.

FIG. 3 is a block diagram of media player 300 configured to receive streaming content in one embodiment according to the present invention. Media player 300 may be embodied as media player 100 of FIG. 1. Media player 300 can be linked to dock 310. Media player 300 may be coupled via wires or wireless using one or more connectors or ports (not shown) to interface with dock 310.

In this example, dock 310 includes antenna 320. Antenna 320 may be integrated into the housing of dock 310 or may protrude therefrom. Dock 310 can be adapted to receive content streams from various sources, including any of the sources and/or formats mentioned above. Dock 310 can be adapted to connect to a data network, e.g., via a wired or wireless connection (not explicitly shown in FIG. 3) to receive content and/or metadata associated with a content stream.

Media player 300 also can include antenna 330. Antenna 330 may be integrated into the housing of media player 300 or may protrude therefrom. Media player 300 can be adapted to receive content streams from various sources using antenna 330, including any of the sources and/or formats mentioned above.

FIG. 4 is a block diagram of media player 400 configured to receive streaming content in one embodiment according to the present invention. Media player 400 may be embodied as media player 100 of FIG. 1. Media player 400 can include integrated receiver 410.

Receiver 410 can be adapted to receive content from various sources, including any of the sources and/or formats mentioned above. Media player 400 can be adapted to connect to a data network, e.g., via a wired or wireless connection (not explicitly shown in FIG. 4) to receive content and/or metadata associated with a content stream.

It will be appreciated that the embodiments of media player 100 described herein are illustrative and that variations and modifications are possible. Media players and/or portable media devices, such as media player 100, may include devices capable of storing and/or playing content or other media assets. Media players and/or portable media devices may include devices capable of content stream receiving capability which may be provided by a detachable receiver accessory or by receiver components built into a device. Further, although embodiments may make specific reference to receiving streaming content from one or more sources, embodiments of media player 100 can function as the source of a content stream.

Media player 100 may also provide additional capabilities (e.g., generating content streams; recording streaming content; making and receiving telephone calls; managing personal information such as contacts and calendar; communicating via e mail, text messaging, instant messaging; etc.) as desired. Although FIGS. 1-4 are described herein with reference to particular blocks and modules, it is to be understood that these blocks and modules are defined for convenience of description and are not intended to imply a particular physical arrangement of component parts. Further, the blocks/modules need not correspond to physically distinct components. For instance, those skilled in the art will appreciate that different combinations of hardware and/or software components may also be used and that particular operations or features described as being implemented in software might also be implemented in hardware or vice versa.

In various embodiments, during the playback or presentation of streaming content (i.e., content or other media assets within a content stream), media player 100 may further present or otherwise initiate the playback of personalized content to be integrated with the streaming content. For example, a user of a media player or portable media device may find it useful to have personal or other information relevant to the user presented to them while the user is listening to terrestrial or Internet radio, watching a movie or television broadcast, or otherwise being presented streaming content. Media player 100 may not only play back media items associated with the streaming content, but may also play back of content that has been generated from one or more data sources identified by a user.

For example, while a portable media player with a WiFi interface is playing a group of songs to a user from network radio station accessible via a wireless network, the user may wish to integrate short segments of audio content in conjunction with or during the transitions of the songs from the network radio station. The short segments of audio content may include content dynamically generated from data sources, such as personal reminders from a calendar, weather information, missed calls or messages from voicemail and e-mail inboxes, to be personalized to the user. As another example, while a media player is playing a video or a group of short videos streamed from an website, such as YouTube, the user may wish to integrate segments of content personalized for the user, such as an animated video clip reminding the user of an upcoming appointment or that an e-mail message has been received, into the video or between the one or more of the short videos. In some embodiments, the personalized content can be the same type or a different type of media than media items being played.

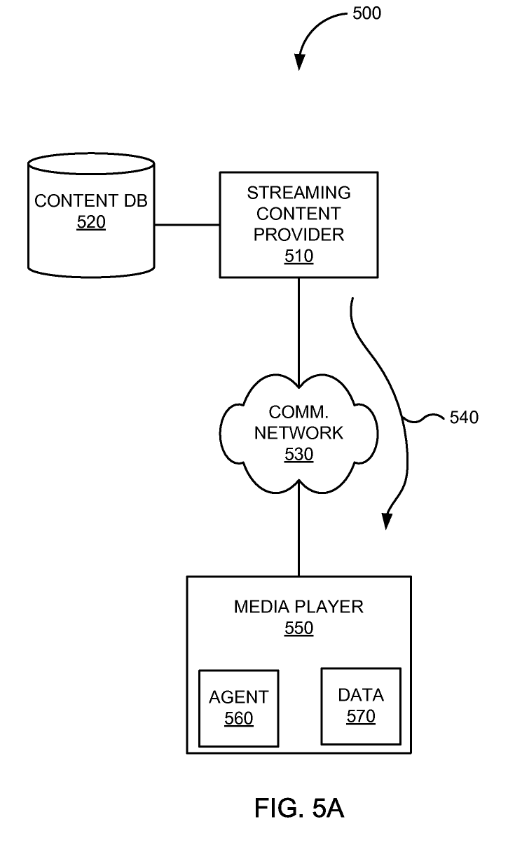

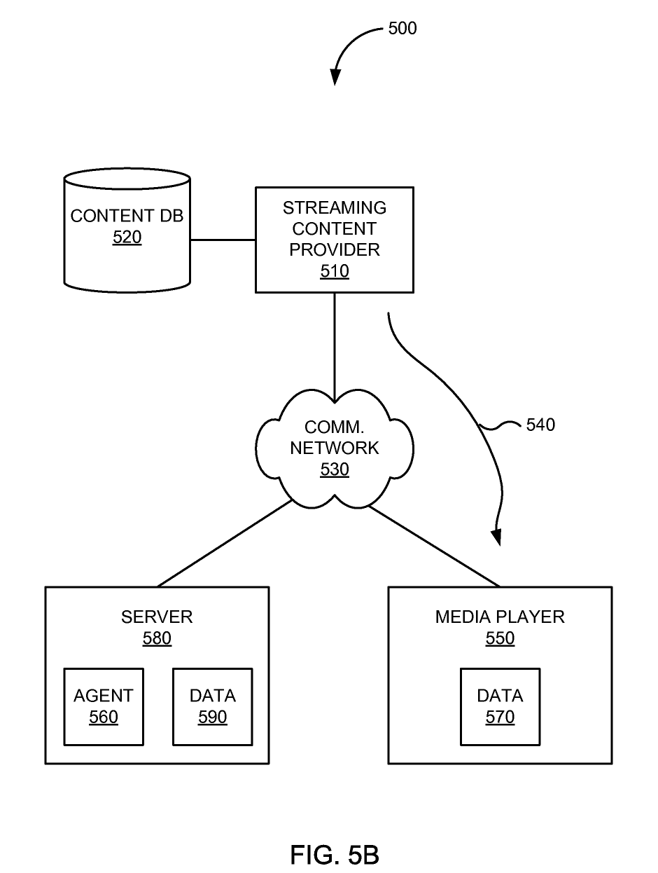

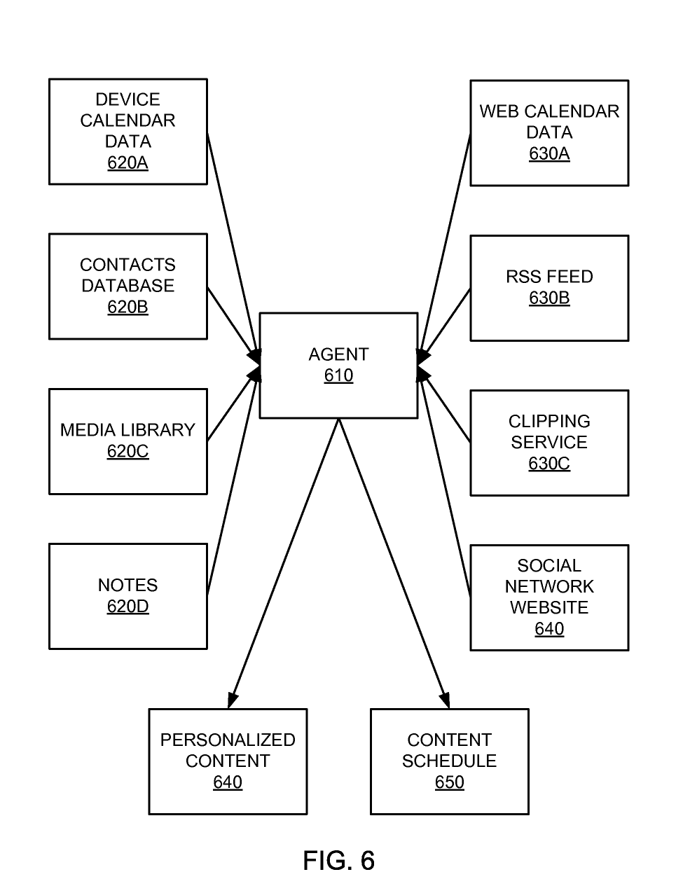

FIGS. 5A and 5B are block diagrams of streaming media systems for presenting personalized content with streaming content in various embodiment according to the present invention. Referring to FIG. 5A, streaming media system 500 can include streaming content provider 510 coupled to content database 520. Streaming content provider 510 can be coupled to communications network 530, which may be embodied as a private network (e.g., a corporate network) or as a public network (e.g., the Internet). In some embodiments, communications network 530 can refer to one or more data networks, typically, high data-bandwidth networks, namely, wired networks, such as the Internet, Ethernet, gigabit Ethernet, and fiber optic, as well as wireless networks such as IEEE 802.11(a), (b), (g), (n), (WiFi), IEEE 802.16 (WiMax), and Ultra-Wide Band (UWB).

Streaming content provider 510 may include hardware and/or software elements configure to transmit content or other media assets stored in content database 520 using communications network 530 as streaming content 540. Streaming content 540 may include one or more of audio content, video content, image/photo content, or the like, and may further include metadata associated with one or more media items within streaming content 540. Additionally, streaming content provider 510 may host an on-line media store or provide other multimedia or information services to users. In some embodiments, streaming content provider 510 may off-load commerce transactions and/or delivery of purchased digital media assets to other servers, if desired.

As shown in FIG. 5A, streaming media system 500 can include media player 550 for use by one or more end users. Media player 550 can be, in general, any computing device. As an example, media player 550 can be a specific or general-purpose personal computer. As another example, media player 550 can be a dedicate media device or portable media player. Media player 550 can be coupled to other electronic devices, such as accessory devices or other portable media devices. Media player 550 can also be coupled to communications network 530.

In various embodiments, media player 550 may include one or more computer programs (e.g., media management applications, media playback applications, games, office and productivity applications, etc.) that can run on or otherwise executed by media player 550. Computer programs run by media player 550 can be used for a variety of purposes, including, but not limited to, browsing, searching, acquiring and/or purchasing media assets (i.e., digital media assets) via an on-line media store, creating and sharing content or other media asset (e.g., music, movies, playlists, etc.), organizing content or other media assets, presenting/playing content or other media assets, transferring content or other media assets, and synchronizing content or other media assets with one or more devices.

In this example, media player 550 can include agent 560. Agent 560 can include hardware and/or software elements configured to use data feeds identified by a user to personalize content for playback in conjunction with one or more media items within streaming content 540. Personalized content may be generated using data obtained from one or more data sources representing the data feeds. Agent 560 may create audio/video/image content personalized from the data feeds or coordinate the creation of the personalized content from the data feeds. For example, agent 560 may use one or more voice synthesis techniques to create audio content representative of data 570 (e.g., MP3 ID tags, text notes, calendar reminder, etc.) stored on media player 550. Agent 560 may further coordinate when the personalized content is to be presented or otherwise played back using media player 550.

In one example of operation of streaming media system 500, streaming content provider 510 streams content or other media assets in streaming content 540 to media player 550 using communications network 530. For example, a user may listen to one or more terrestrial analog or hybrid-digital (HD) radio stations broadcast by streaming content provider 51O. In another example, media player 500 may utilize a wireless network to acces various Internet radio stations offered by one or more servers associated with streaming content provider 510. Media player 550 may output or play back content and/or other media assets associated with streaming content 540.

In addition to streaming content 540, media player 550 may output content that has been specifically personalized for a user or group of users. For example, in one embodiment, agent 560 may dynamically create content that includes content personalized from data 570 or data obtained from one or more other data sources (not shown) on media player 550. In another embodiment, agent 560 may coordinate the creation and delivery of personalized content to media player 550 that includes content generated to be personalized from information obtained from one or more other data sources (not shown) external to media player 550.

Referring to FIG. 5B, in another example of operation, streaming media system 500 may include server 580 coupled to communications network 530. Server 580 may include agent 560. Agent 560 may generate personalized content on server 580 or coordinate the creation of personalized by another computer system or device other than server 580 (e.g., on media player 550). Agent 560 may generate content personalized from data 570 stored on media player 550 or from data 590 stored on server 580. Data 590 may include information obtained from other sources (not shown), such as websites, newsgroups, RSS feeds, or the like. In various embodiments, personalized content can be delivered to media player 550 for storage and retrieval for subsequent playback. Accordingly, media player 550 can present not only media items associated with streaming content 540 received from streaming content provider 510, but also personalized content that may be dynamically generated from data obtained from other data sources. In one aspect, information in which a user is interested can be automatically obtained from various data sources and dynamically converted into audio/video/image content for presentation to the user of media player 550 in conjunction with other streaming content.

FIG. 6 is a block diagram of agent 610 configured to generate personalized content based on information obtained from one or more data sources for playback with streaming content in one embodiment according to the present invention. Agent 610 may be embodied as agent 560 of FIG. 5A, as discussed above. In one example, agent 610 may obtain data or other information from data sources identified by a user that are hosted by a media player or portable media device. Some examples of data or data sources hosted by a media player may include device calendar data 620A, contacts database 620B, media library 620C, notes 620D, or the like. Additionally, agent 610 may data or other information from data sources identified by a user that are hosted by devices or computers systems external to or otherwise not associated with agent 610. Some examples of external data or external data sources may include web calendar data 630A, RSS feed 630B, clipping service 630C, social network website 640D, or the like. In some embodiments, agent 610 may obtain information, such as calendar information, event information, voicemails, e-mails, instant messages, metadata associated with content, or the like, from a single data source. In further embodiments, agent 610 may aggregate information obtained from any number of data sources.

In one example of operation, agent 610 may generate personalized audio or video content based on calendar appointments, weather information, voicemail, etc. Agent 610 then may present the personalized content to a user of a media player or portable media device (e.g., media player 550 of FIG. 5A) in conjunction with streaming content (e.g., streaming content 540 of FIG. 5A). Accordingly, the user of the media player or portable media device may be provided with audible reminders, visual graphics, movie and motion sequence clips, or the like, that have been personalized to the user from data feeds selected by the user and interjected into a program or in-between programs within streaming content.

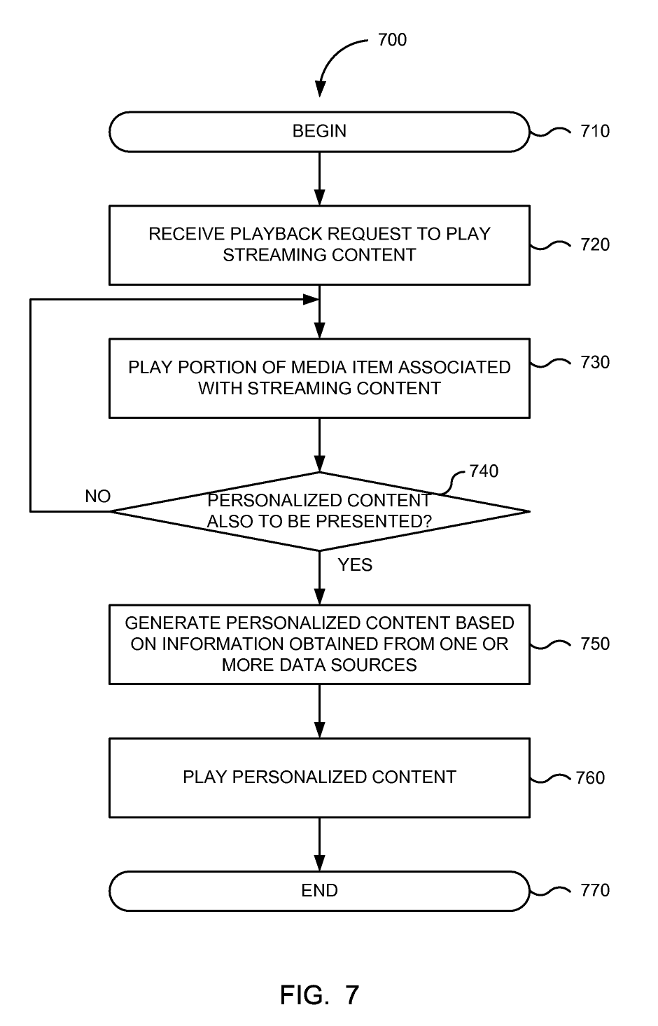

FIG. 7 is a flowchart of method 700 for presenting personalized content with streaming content in one embodiment according to the present invention. The processing depicted in FIG. 7 may be performed by software modules (e.g., instructions or code) executed by a processor of a computer system, by hardware modules of an electronic device, or combinations thereof. FIG. 7 begins in step 710.

In step 720, a playback request to play streaming content is received. A playback request may occur automatically or in response to user input. As an example, a user interacting with an electronic device configured to present media items associated with streaming content for playback can request playback of one or more of the media items. The streaming content may include broadcast radio, television, Internet radio, podcasts, real-time content, or the like. The media items can include songs, albums, movies, photos, images, or the like.

In step 730, a portion of a media item associated with the streaming content is played. In one example, a user may connect a WiFi-enabled portable media player to a wireless access point and subscribe to an Internet radio station, upon which the portable media player initiates playback of the currently playing media item.

In step 740, a determination is made whether personalized content is also to be presented. For example, agent 560 associated with media player 550 of FIG. 5A may determine to initiate playback of the personalized content at random or scheduled intervals. In another example, agent 560 may be configured to present personalized content for playback in response to the occurrence of an event, such as a timer or notification. In yet another example, agent 560 may make the determination based on one or more user preferences.

User preferences may include when personalized content should be presented, what data sources or data feeds should be used to construct or otherwise generate the personalized content, the verbosity of the personalized content (e.g., how much information should be presented or represented by the dynamic content), or the like. In some embodiments, information about the location of an electronic device may be used in the determination whether personalized content is also to be presented. For example, a user that listens to Jazz at work may desire to have content personalized from a work e-mail account or work calendar to be also played back in addition to a network accessible Jazz station.

In another example, GPS and direction information may be used in the determination whether personalized content is also to be presented. For example, in addition to vocalizing using personalized content the GPS and direction information when a user is driving a car, riding a bicycle, or walking, a user's location, heading, altitude, etc. may be used as a trigger to begin presenting personalized content. In further embodiments, usage information may be used in the determination whether personalized content is also to be presented. For example, a history may include information on when and how often a user listens to a particular station. The history may be used as a trigger to include personalized content. Combinations of location and usage may also be used.

If a determination is made not to present any personalized content with the streaming content, the processing continues in step 730 and playback the media item continues. Alternatively, when a determination is made to present personalized content in step 740, the personalized content can be generated based on information obtained from one or more data sources in step 750. The personalized content can be generated to include any content or media asset, such as audio content, video content, image content, textual information, multimedia information, or the like. The information obtained from the one or more data sources, for example, can pertain to personal data associated with a user, such as horoscopes, calendar entries, upcoming appointments or social events, task reminders, grocery or to-do lists, caller ID, voicemail, e-mail, instant messages, weather information, traffic updates, news, or other advertising information.

In various embodiments, the personalized content may be created or generated using one or more voice synthesis or speech synthesis techniques. In general, voice synthesis or speech synthesis can include the artificial production of human speech. A voice or speech synthesizer can be implemented in hardware and/or software. In one example, a text-to-speech (TTS) system may convert normal language text into speech or render symbolic linguistic representations like phonetic transcriptions into speech. In one embodiment, one or more voice synthesis or TTS techniques may be used to pre-record or pre-render audio clips, for example, when a TTS engine is not available on a device. In some embodiments, synthesized speech can be created by concatenating pieces of recorded speech. The recorded speech may be stored in a database on a media player or portable media device or on a server accessible to a media player. Alternatively, a synthesizer can incorporate a model of a vocal tract and other human voice characteristics to create a synthetic or synthesized voice output.

In one example, a computer system may retrieve a configuration settings for a text-to-speech conversion process. The configuration settings can control various aspect of the voice synthesis or text-to-speech conversion process. For example, the configuration settings can determine information to be converted into audio files, quality of the TTS conversions, gender of the voice that verbalizes the information, the speed at which information is audiblized or vocalized, and customizing voices to different subtasks (e.g., certain types of information can be audiblized with one voice while other different types of information can be audiblized with a different voice).

Various sound synthesizer rules and engines can be used to generate the audio file. A generalized example of a process for converting a word into an audio file can operate as follows. The process for converting the word “browse” begins by breaking the word into fragments that represent diphone units or syllables, such as “b” “r” “ow” “s”. Then various techniques generate audio data for each component, which can then be combined to form an intelligible word or phrase. The audio data may be pre-recorded, for example, and given an extension that corresponds to the type of audio file created. For example, the audio file for “browse” can be identified by a browse.aiff filename, wherein the .aiff extension indicates an audio file.

In yet another example, the personalized content may include one or more still images or motion picture sequences dynamically generated from text, images, audio data, and/or video data. Personalized content that is dynamically generated, such as in real-time or on-the-fly when needed may be referred to herein as dynamic content. In another example, the personalized content may include a sampling of a selection of one or more media items. As other alternatives, the personalized content may be generated based on usage history, user preferences, device configurations, or playback rules from a third-party (e.g., remote media provider).

After the personalized content has been generated in step 750, the personalized content is played in step 760. In some embodiments, the portion of the media item currently playing and the personalized content can be mixed or played simultaneously. For example, a voice synthesized audio commentary may be played during a song that describes the song, the album on which it may be found, the background of the artist, purchasing information, or other metadata that may be associated with the song. The personalized audio commentary may be dynamically generated before the song is played or while the song is played. In another example, a personalized movie clip may be played in a picture-in-picture format during playback of a feature film. The personalized movie clip may include motion picture sequences representing the current or forecast weather generated from a weather data feed or a countdown timer illustrating the time remaining and reminding the user of an upcoming event scheduled in a user's calendar.

In some embodiment, playing the personalized content in step 760 can include interjecting personalized audio or video content in the transition between an ending media item and another media item about to begin in the streaming content. For example, at the end of a song, a personalized audio clip generated in real-time used voice synthesis may be played to remind the listener of an upcoming dentist appointment. In further embodiments, playing the personalized content in step 760 can pertain to displaying of personalized image or video content in conjunction with a media item in the streaming content. For example, the personalized content can be presented simultaneously, overlayed, mixed, provided in a picture-in-picture format, provided in a pop-up or bubble, subtitle, or the like.

In various embodiments, personalized content may be generated and stored for future use. Selection of stored personalized content can be determined based on one or more criterion. Personalized content may be retrieved from storage that is locally available to a media player or portable media device. In some embodiments, personalized content may be generated externally to a media player and maintained at a central media repository. Media devices can access the media repository via a network to acquire the personalized content. Additionally, personalized content that has been previously acquired from the media repository can be refreshed or updated, such as by subsequent access to the media repository. As discussed, presenting of the streaming content and the personalized content can be achieved in a variety of different ways. FIG. 7 ends in step 770.

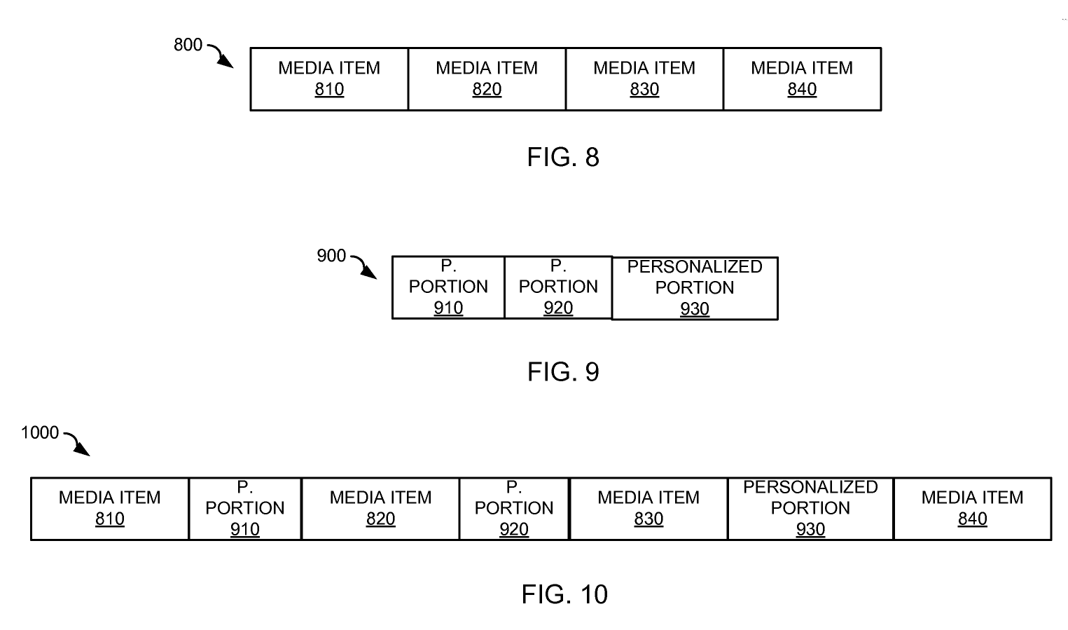

FIG. 8 is a diagram of conventional playback of streaming content 800 in one embodiment according to the present invention. In this example, streaming content 800 can include four (4) media items, namely, first media item 810, second media item 820, third media item 830, and fourth media item 840. The playback of streaming content 800 operates to sequentially play media items 810, 820, 830, and 840. For example, initially first media item 810 is played. After the playback of first media item 810 has completed, second media item 820 is played. After the playback of second media item 820 has completed, third media item 830 is played. After the playback of third media item 830 has completed, fourth media item 840 is played. After the playback of fourth media item 840 has completed, the playback of streaming content 810 is complete.

FIG. 9 is a diagram of personalized content 900 generated according to one embodiment of the present invention. Personalized content 900 can pertain to one or more dynamically generated or personalized media items generated to be based on information received from one or more data sources. As shown in FIG. 9, personalized content 900 is divided into portions. In this example, personalized content 900 can include three (3) portions, namely, first personalized portion 910, second personalized portion 920, and third personalized portion 930. The personalized portions can also be referred to as personalized segments (e.g., segmented into one or more personalized segments).

FIG. 10 is a diagram of playback of interlaced media data 1000 in one embodiment according to the present invention. In various embodiments, after playback of one or more of the media items in streaming content 800 of FIG. 8, a particular portion of personalized content can be played from personalized content 900 of FIG. 9. In other words, playback of the segments of personalized content 900 can be alternated or interleaved with playback of the media items of streaming content 800. In the example illustrated in FIG. 10, first media item 810 of streaming content 800 can be initially played. After the playback of first media item 810 has completed, first personalized portion 910 of personalized content 900 can be played. After the playback of first personalized portion 910 has completed, second media item 820 of streaming content 800 can be played. After the playback of second media item 820 has completed, second personalized portion 920 of personalized content 900 can be played. After the playback of second personalize portion 920 has completed, third media item 830 of streaming content 800 can be played. After the playback of third media item 830 has completed, third personalized portion 930 of personalized content 900 can be played. After the playback of third personalized portion 930 has completed, fourth media item 840 of streaming content 800 can be played. After the playback of fourth media item 840 has completed, the playback of interlaced media data 1000 can be complete.

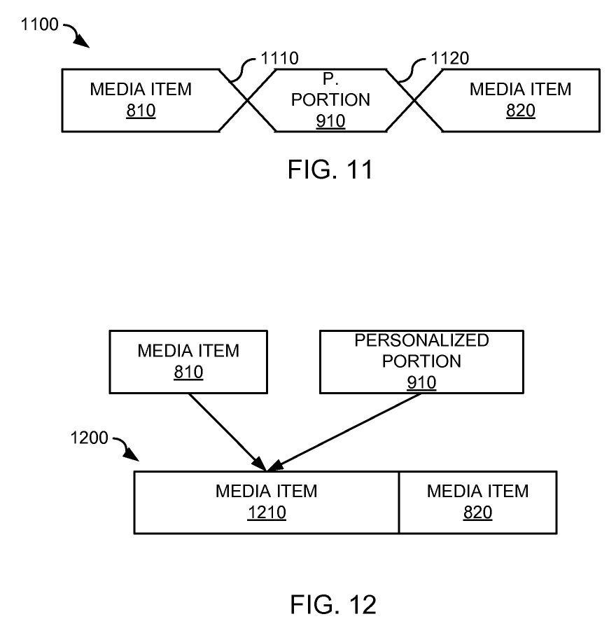

FIG. 11 is a diagram of playback of interlaced media 1100 in one embodiment according to the present invention. Interlaced media data 1100 can be similar to interlaced media data 1100 illustrated in FIG. 11, except that interlaced media data 1100 further includes one or more transition effects at transitions between media items 810, 820, 830, and 840 of streaming content 800 and personalized portions 910, 920, and 930 of personalized content 900. One example of a transition effect is a cross-fade. FIG. 11 illustrates first cross-fade 1110 at a transition from first media item 810 of streaming content 800 and first personalized portion 910 of personalized content 900, and second cross-fade 1120 at a transition from first personalized portion 910 and second media item 820 of streaming content 800.

FIG. 12 is a diagram of playback of combined media data 1200 in one embodiment according to the present invention. In this example, first media item 810 of streaming content 800 is combined with first personalized portion 810 of personalized content 900 to create media item 1210. For example, audio data representing a song may be combined with personalized audio data, such that a listener simultaneously hears both the song and the personalized audio data. After the playback of media item 1210 has completed, second media item 820 of streaming content 800 can be played.

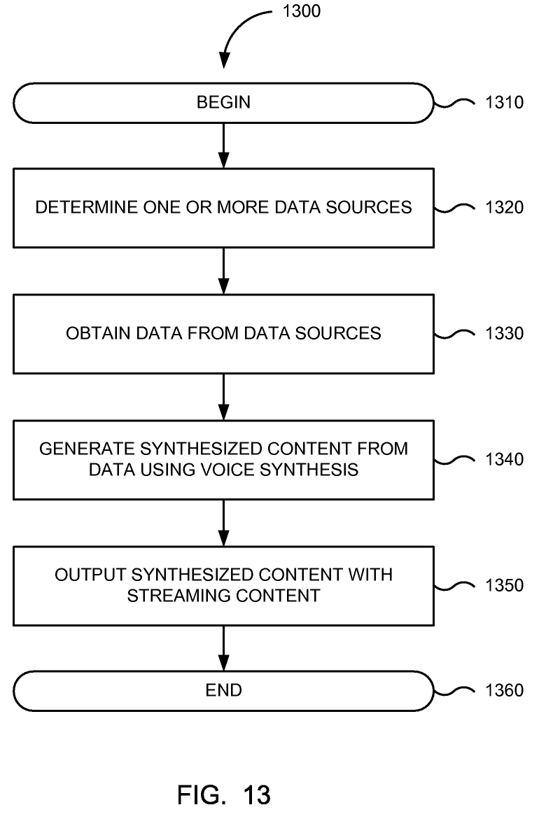

FIG. 13 is a flowchart of method 1300 for presenting personalized content generated using voice synthesis in one embodiment according to the present invention. FIG. 13 begins instep 1310.

In step 1320, one or more data sources are determined. For example, agent 610 of FIG. 6 may enumerate or determine sources of information hosted by a media player or portable media device on which agent 610 executes, sources of information locally accessible to the media player or portable media device on which agent 610 executes, sources of information accessible via a communications network, or the like. In some embodiments, a user may interact with a graphical user interface to enter information specifying resource or location information for data feeds, such as URLs, RSS feeds, etc.

In step 1330, data is obtained from the one or more data sources. In one example, agent 610 can query a calendar application hosted by a device to obtain device calendar data 620A. In another example, agent 610 may obtain caller ID information from an incoming phone call. In yet another example, agent 610 may cause XML data associated with an RSS feed to be downloaded from the Internet. In a further example, agent 610 may access a user profile associated with a URL for a social networking site to obtain information, such as horoscope data, weather data, chat data, comment posting data, page view data, or the like, provided by one or more applets or widgets embedded in the social networking site for the user profile.

In step 1340, synthesized content is generated from the data using voice synthesis. Using one or more voice synthesis techniques, a computer generated voice may be recorded as reading textual information in the data. In another example, audio content may be generated of a computer synthesized voice reading a weather report. In other examples, audio content may be generated of a computerized voice reading an e-mail, describing from whom a voicemail was received, reading the top news headlines, announcing an incoming call, reading a summary of a song or movie, or the like.

A user may be able to configure one or more user preferences related to voice synthesis. For example, the user may specify the gender of the voice actor, the pitch, the frequency or speed, volume, or the like. The voice synthesis techniques may take advantage of pre-recorded content in synthesizing the content. For example, audio data representing pre-recorded words may be used to generate the synthesized voice. In another example, portions of a voicemail or voice chat may be used to generate the synthesized voice. A user may record his/her own voice to be used when generating the synthesized voice.

Referring again to FIG. 13, in step 1350, the synthesized content is output with streaming content. For example, audio data synthesized from the textual summary of an audio book may be played to a user upon initiating wireless streaming of the audio book to the users media player. In yet another example, in between songs of an Internet radio station, audio data synthesized from a calendar appointment, a task reminder, an e-mail, a horoscope, weather data, traffic update, incoming voicemail or instant messages, or the like, may be output to the user. In further embodiments, a computer-generated image may be displayed in one corner of a movie being streamed to a set-top box. The computer-generate image may include a photo obtained from a contact database of a person placing a Voice-over-IP (VoiP) call, caller ID information, a call history of calls placed to and received from the person, and other information obtained about the person.

Accordingly, data or other information desired by a user can be output in conjunction with streaming content in the form of audio/video/image content dynamically generated from the data. Voice synthesis may be used to create content personalized from the data. Synthesized voice content may be automatically created by a media player or portable media device in real-time to be played back with streaming content. In some embodiments, the synthesized content may be downloaded and stored on the media player for subsequent retrieval during the output of streaming content. FIG. 13 ends in step 1360.

Another aspect of the invention pertains to when content generated from personalized data feeds is to be presented (e.g., played) by an electronic device in conjunction with streaming content. Typically, but not necessarily, the presentation of the personalized content can be provided when media items associated with streaming content are not being presented, such as between presentation of distinct media items. The presentation can be controlled or influenced by user preferences, usage history, media item characteristics, availability of dynamic content, availability or accessibility of data sources, system configuration settings, or the like. In one embodiment, once enabled or activated, the presentation of dynamic content can be automatically provided.

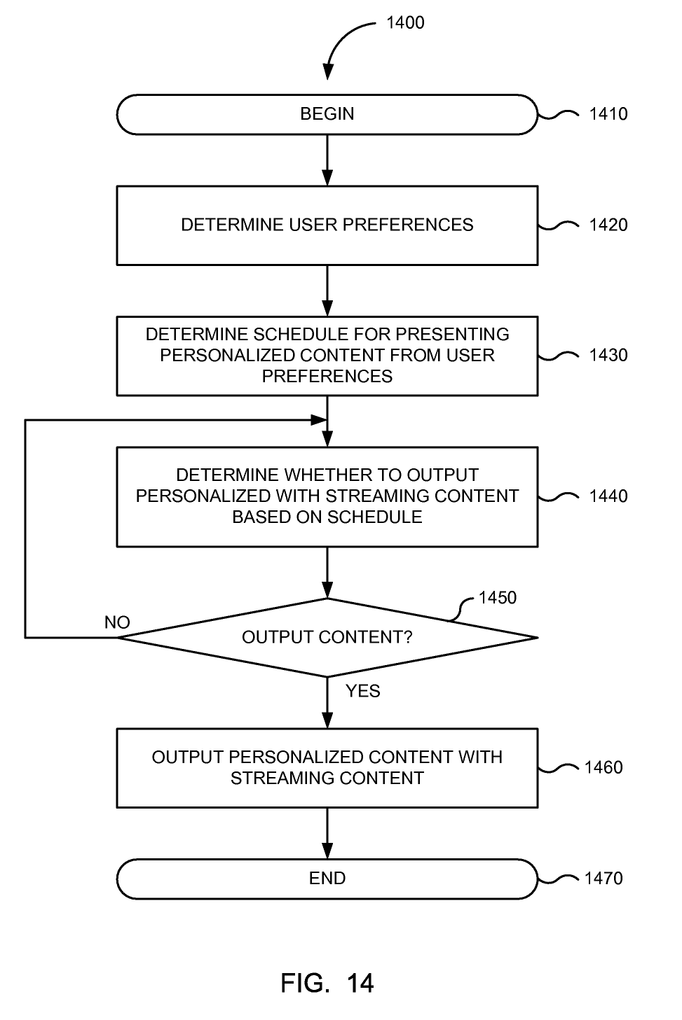

FIG. 14 is a flowchart of method 1400 for presenting personalized content based on a schedule in one embodiment according to the present invention. FIG. 14 begins in step 1410.

In step 1420, one or more user preferences are determined. In step 1430, a schedule for presenting personalized content is determined from the one or more user preferences. A schedule may include information for presenting the personalized content at a random time, at random intervals, at a predetermined time, at predetermined intervals, or the like. In step 1430, a determination is made whether to output personalized content with streaming content based on the schedule.

In some embodiments, the schedule may be invoked in response to one or more timers. A timer may be configured to hardware and/or software elements to generate an event. Based on occurrence of an event, a positive determination to output the dynamic content may be made. In various embodiments, the schedule may be invoked based on one or more of a variety of different criteria. For example, the schedule may be invoked based on one or more of: (i) a media item within streaming media, (ii) a random characteristic, (iii) prior usage or user history, (iv) user preferences, (v) third-party preferences, (vi) keywords, (vii) advertising preferences, etc. If it is determined not to output the personalized content in step 1450, the processing continues in step 1440.

If it is determined to output personalized content in step 1450, the personalized content is output in step 1460. In some embodiments, the personalized content can be output at random intervals in between songs within streaming content. In further embodiments, the personalized content may be output regularly in between songs, every half-hour, or every few minutes based on the user hitting a “snooze” button. In still further embodiments, the schedule may be modified based on the data used to generate the personalized content, such as the start time of a calendar appointment, or a reminder time of a task list.

In some embodiments, a media retrieval process may be performed, for example, by determining personalized content to be retrieved. The determination of the personalized content to be retrieved can be based on one or more of a variety of different criteria. In further embodiments, a media refresh process may be performed, for example, by refreshing or updating personalized content that is to be utilized. For example, personalized content stored on a media player or portable media device may be refreshed or updated by server 580 illustrated in FIG. 5B. In another example, a media player and/or portable electronic device can have at least a portion of their personalized content updated or refreshed. As yet another example, the replacement personalized content can be requested from a media repository (e.g., server 580). FIG. 14 ends in step 1470.

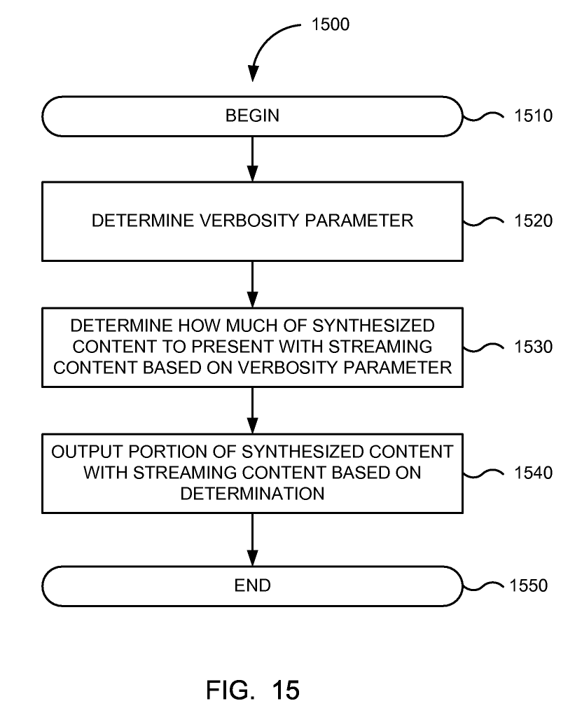

FIG. 15 is a flowchart of method 1500 for presenting synthesized content based on a verbosity parameter in one embodiment according to the present invention. FIG. 15 begins in step 1510.

In step 1520, a verbosity parameter is determined. A verbosity parameter can include any value, threshold, limit, or indicator representing how much synthesized content to be output when generated from the personalized data feeds. The verbosity parameter may indicate that how much of the synthesized content should be generated. The verbosity parameter may further indicate how much of the synthesized content already generated is to be selectively output with streaming content. For example, a value associated with the verbosity parameter may have a range from 0 to 10, with 0 representing that no synthesized content is to be output or generated and 10 representing all synthesized content should be output. In another example, a verbosity parameter may indicate that merely highlights of the synthesized content may presented or that as much content should be generated as possible from the data obtained from a data source for presentation to the user.

In step 1530, how much of synthesized content to present with streaming content is determined based on the verbosity parameter. For example, the verbosity parameter may indicate that synthesized content may be generated from each data feed established by a user each time a determination is made to output synthesized content. In another example, the verbosity parameter may indicate that synthesized content is to be output for a selective portion of the data feeds which are most accessed by the user. In yet another example, the verbosity parameter may indicate that only selective portions of the synthesized content itself is to be output. Thus, not all portions of synthesized dynamically generated from data obtained from a data source may be presented to a user.

In step 1540, a portion of the synthesized content is output with the streaming content based on the determination. FIG. 15 ends in step 1550.

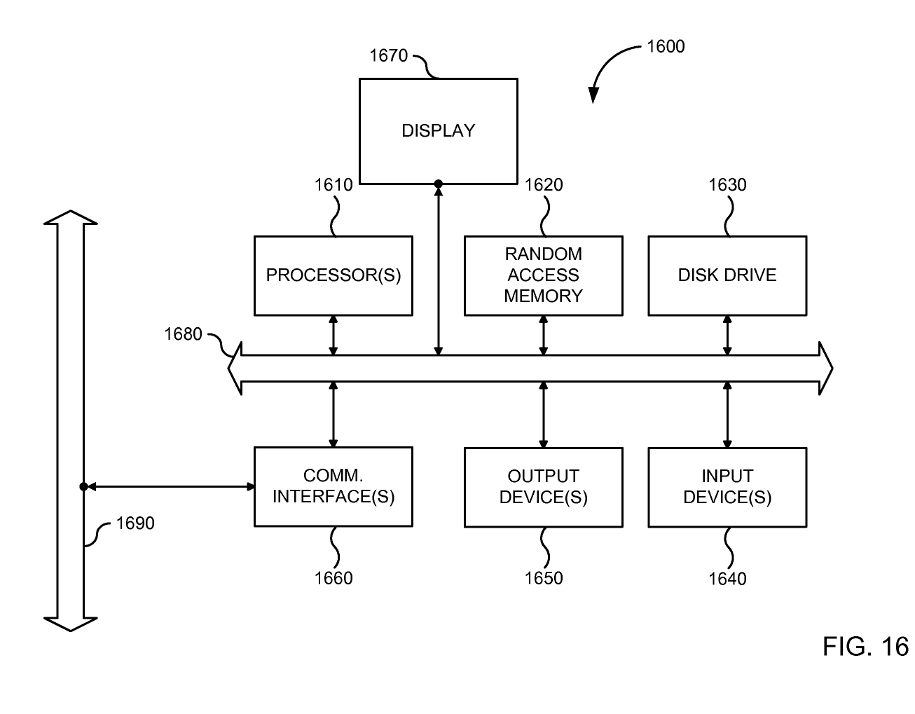

FIG. 16 is a simplified block diagram of a computer system 1600 that may incorporate embodiments of the present invention. FIG. 16 is merely illustrative of an embodiment incorporating the present invention and does not limit the scope of the invention as recited in the claims. One of ordinary skill in the art would recognize other variations, modifications, and alternatives.

In one embodiment, computer system 1600 includes processor(s) 1610, random access memory (RAM) 1620, disk drive 1630, input device(s) 1640, output device(s) 1650, display 1660, communications interface(s) 1670, and a system bus 1680 interconnecting the above components. Other components, such as file systems, storage disks, read only memory (ROM), cache memory, codecs, and the like may be present.

RAM 1620 and disk drive 1630 are examples of tangible media configured to store data such as audio, image, and movie files, operating system code, embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROMS), battery-backed volatile memories, networked storage devices, and the like.

In various embodiments, input device 1640 is typically embodied as a computer mouse, a trackball, a track pad, a joystick, a wireless remote, a drawing tablet, a voice command system, an eye tracking system, a multi-touch interface, a scroll wheel, a click wheel, a touch screen, an FM/TV tuner, audio/video inputs, and the like. Input device 1640 may allow a user to select objects, icons, text, and the like, via a command such as a click of a button or the like. In various embodiments, output device 1650 is typically embodied as a display, a printer, a force-feedback mechanism, an audio output, a video component output, and the like. Display 1660 may include a CRT display, an LCD display, a Plasma display, and the like.

Embodiments of communications interface 1670 may include computer interfaces, such as include an Ethernet card, a modem (telephone, satellite, cable, ISDN), (asynchronous) digital subscriber line (DSL) unit, FireWire interface, USB interface, and the like. For example, these computer interfaces may be coupled to a computer network 1690, to a FireWire bus, or the like. In other embodiments, these computer interfaces may be physically integrated on the motherboard or system board of computer system 1600, and may be a software program, or the like.

In various embodiments, computer system 1600 may also include software that enables communications over a network such as the HTTP, TCP/IP, RTP/RTSP protocols, and the like. In alternative embodiments of the present invention, other communications software and transfer protocols may also be used, for example IPX, UDP or the like.

In various embodiments, computer system 1600 may also include an operating system, such as Microsoft Windows®, Linux®, Mac OS X®, real-time operating systems (RTOSs), open source and proprietary OSs, and the like.

FIG. 16 is representative of a media player and/or computer system capable of embodying the present invention. It will be readily apparent to one of ordinary skill in the art that many other hardware and software configurations are suitable for use with the present invention. For example, the media player may be a desktop, portable, rack-mounted or tablet configuration. Additionally, the media player may be a series of networked computers. Moreover, the media player may be a mobile device, an embedded device, a personal digital assistant, a smart phone, and the like. In still other embodiments, the techniques described above may be implemented upon a chip or an auxiliary processing board.

The present invention can be implemented in the form of control logic in software or hardware or a combination of both. The control logic may be stored in an information storage medium as a plurality of instructions adapted to direct an information-processing device to perform a set of steps disclosed in embodiments of the present invention. Based on the disclosure and teachings provided herein, a person of ordinary skill in the art will appreciate other ways and/or methods to implement the present invention.

The embodiments discussed herein are illustrative of one or more examples of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, the present descriptions and drawings should not be considered in a limiting sense, as it is understood that the present invention is in no way limited to only the embodiments illustrated.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A method for presenting streaming content by a media player configured to provide playback of one or more media items in the streaming content, the method comprising:
receiving a playback request to play the streaming content;
playing a portion of a media item associated with the streaming content;
determining whether personalized content is also to be played with the streaming content, the personalized content generated based on information obtained from a data source; and
playing the personalized content based on a determination that personalized content is also to be played with the streaming content.

2. The method of claim 1 wherein determining whether the personalized content is also to be played with the streaming content comprises determining whether to initiate playback of the personalized content in response to a request by a user.

3. The method of claim 1 wherein determining whether the personalized content is also to be played with the streaming content comprises determining whether to initiate playback of the personalized content in response to one or more user preferences.

4. The method of claim 3 wherein the one or more user preferences include information specifying that the personalized content is to be played back with the streaming content at one or more random intervals.

5. The method of claim 3 wherein the one or more user preferences include information specifying that the personalized content is to be played back with the streaming content at one or more scheduled intervals.

6. The method of claim 3 wherein the one or more user preferences include information specifying a verbosity associated with how much of the personalized content is also to be played with the streaming content.

7. The method of claim 1 further comprising:
obtaining the information from the data source, the information including textual information; and
generating a portion of the personalized content using voice synthesis based on a portion of the textual information.

8. The method of claim 7 wherein the portion of the personalized content is generated by the media player.

9. The method of claim 1 wherein the personalized content is obtained from a source different than the source of the streaming content.

10. The method of claim 1 further comprising:
determining information associated with an event from the more data source; and
generating a portion of the personalized content to include audio content representative of the event.

11. The method of claim 1 further comprising:
determining whether a communication directed to a user associated with the media player has been received from the data source; and
generating a portion of the personalized content to include audio content indicative of the communication.

12. The method of claim 11 wherein the portion of the personalized content includes audio content representative of a voicemail.

13. The method of claim 11 wherein the portion of the personalized content includes audio content representative of an e-mail.

14. The method of claim 1 further comprising:
determining metadata associated with the media item in the streaming content from the data source; and
generating a portion of the personalized content to include audio content representative of the metadata associated with the media item.

15. The method of claim 14 wherein the metadata includes one or more of track information, title information, artists information, album information, or genre information.

16. The method of claim 1 wherein playing the personalized content comprises playing the personalized content during a transition between the portion of a media item and another media item associated with the streaming content.

17. The method of claim 1 wherein playing the personalized content based on a determination that personalized content is also to be played with the streaming content comprises playing a portion of the personalized content simultaneously with the portion of the media item.

18. The method of claim 1 further comprising:
storing the personalized content on the media player; and
retrieving the personalized content in response to a determination that personalized content is also to be played with the streaming content.

19. The method of claim 1 further comprising:
receiving the streaming content via a wireless communications interface.

20. The method of claim 1 wherein the media player is a portable media player.

21. The method of claim 20 wherein the portable media player comprises a handheld or wearable device.

22. A method for presenting streaming content by a portable electronic device supporting playback of one or more media items in the streaming content, the method comprising:
receiving a portion of a media item associated with the streaming content via a wireless communications interface;
playing the portion of a media item associated with the streaming content;
obtaining synthesized content that is also to be played with the streaming content, the synthesized content generated based on information obtained from a data source local to the portable electronic device; and
playing the synthesized content based on a determination that synthesized content is also to be played with the streaming content.

23. The method of claim 22 further comprising:
obtaining the information from the data source local to the portable electronic device; and
creating the synthesized content based on the information using the portable electronic device.

24. The method of claim 22 further comprising:
transmitting the information from the data source local to the portable electronic device to a computer system via the wireless communications interface; and
receiving the synthesized content from the computer system via the wireless communications interface, the synthesized content generated based on the information using the computer system.

25. The method of claim 22 wherein generating the synthesized content further includes:
determining whether a voicemail directed to a user of the portable electronic device has been received based on the information; and
generating a portion of the synthesized content using voice synthesis based on information associated with the voicemail.

26. The method of claim 25 wherein the portion of the synthesized content includes a portion of the voicemail.

27. The method of claim 25 wherein the portion of the synthesized content includes caller ID information.

28. The method of claim 22 wherein generating the synthesized content further includes:
determining whether an e-mail or instant message directed to a user of the portable electronic device has been received based on the information; and
creating a portion of the synthesized content using voice synthesis based on information associated with the e-mail or instant message.

29. The method of claim 22 wherein generating the synthesized content further includes:
determining information associated with a calendar entry based on the information; and
creating a portion of the synthesized content using voice syntheses based on the information associated with the calendar entry.

30. A computer readable storage medium configured to store a set of code modules which when executed by a processor of an electronic device become operational with the processor for presenting streaming content by the electronic device to provide playback of one or more media items in the streaming content, the computer readable storage medium comprising:
code for receiving a playback request to play the streaming content;
code for playing a portion of a media item associated with the streaming content;
code for determining whether personalized content is also to be played with the streaming content, the personalized content generated based on information obtained from one or more data sources; and
code for playing the personalized content based on a determination that personalized content is also to be played with the streaming content.

31. An electronic device comprising:
a communications interface configured to receive streaming content;
a media playback subsystem coupled to the communications interface, the media playback subsystem configured to receive a playback request to play the streaming content, to play a portion of a media item associated with the streaming content, to determine whether personalized content is also to be played with the streaming content, the personalized content generated based on information obtained from one or more data sources is to be played, and to play the personalized content based on a determination that personalized content is also to be played with the streaming content.

32. The electronic device of claim 31 wherein the media playback subsystem is configured to receive the streaming content using the communications interface from a wireless network.

33. The electronic device of claim 31 further comprising:
a voice synthesis module configured to generate audio content to be included in the personalized content from the information from the one or more data sources.

34. The electronic device of claim 31 further comprising:
a user interface configured to receive a set of user preferences, a first user preference determining when the personalized content is also to be played with the streaming content and a second user preference determining how much of the personalized content is also to be played with the streaming content.

35. The electronic device of claim 31 further comprising:
a storage subsystem configured to allow storage and retrieval of the personalized content and the information from the one or more data sources.

36. A portable media device for presenting streaming content, the portable media device comprising:
a storage device;
a wireless communications interface configured to receive a portion of a media item associated with the streaming content; and
a processor configured to play the portion of a media item associated with the streaming content, to receive personalized content that is also to be played with the streaming content, the personalized content generated based on information obtained from the storage device, and play the personalized content based on a determination that personalized content is also to be played with the streaming content.

37. The portable media device of claim 36 wherein the processor is configured to create a portion of the personalized content using voice synthesis of textual information in the information obtained from the storage device.
